(19) United States
(12) Patent Application Publication
(10) Pub. No.: US 2019/0108756 A1
(43) Pub. Date: Apr. 11, 2019

(54) SYSTEM AND METHOD FOR TRACKING AND LOGGING ASSET ACTIVITY

(71) Applicant: Blue Oceans Satellite Systems Inc., St. John's (CA)

(72) Inventor: Mark Gillingham, St. John's (CA)

(21) Appl. No.: 16/157,850

(22) Filed: Oct. 11, 2018

Related U.S. Application Data
(60) Provisional application No. 62/570,834, filed on Oct. 11, 2017.

(51) Int. Cl. G08G 1/00; G08C 17/02; G06F 21/31; H04W 4/029

(52) U.S. Cl. CPC G08G 1/20; H04W 4/029; G06F 21/31; G08C 17/02

(57) ABSTRACT

System and method of monitoring asset activities are described. A method of monitoring activities of an asset includes authenticating a user associated with an electronic device; receiving a selection of a customer; sending a list of available assets associated with the customer to the electronic device; receiving a selection of an asset from the user; in response to receipt of the selection, associating the asset with the user; receiving, from the electronic device, measurement data related to the asset; and displaying state of the asset from the measurement data.

### RELATED APPLICATIONS

This application relates to U.S. provisional patent application No. 62/570,834, filed Oct. 11, 2017, entitled SYSTEM AND METHOD FOR TRACKING AND LOGGING ASSET ACTIVITY, which is incorporated herein by reference.

### FIELD

The present application relates to asset management, in particular, to system and method for tracking and recording asset activity.

### BACKGROUND

Organizations, such as public organizations or private companies, often engage third party service provider for providing services. Service providers may be contractors, or companies. For example, municipal governments may use contractor services in winter operations, waste services, construction, and mowing and landscaping, etc. Sometimes, it is difficult to timely track or evaluate the work completed by the service provider, or it is difficult for the service provider to verify the work completed by their employees.

As well, organizations wish to accurately track and manage assets, such as contractor fleets. For example, some municipal governments engaged over two thousand contractor vehicles for winter operations alone, and have significant operational and financial exposure due to a lack of viable, easy to use solution.

### SUMMARY

The present application provides a simple and cost-effective solution for tracking and recording asset activities, such as government and contractor fleets.

According to an aspect of the present application, there is provided a method of monitoring activities of an asset, comprising: authenticating a user associated with an electronic device; receiving a selection of a customer; sending a list of available assets associated with the customer to the electronic device; receiving a selection of an asset from the user; in response to receipt of the selection, associating the asset with the user; receiving, from the electronic device, measurement data related to the asset; and displaying state of the asset from the measurement data.

According to an aspect of the present application, there is provided a system for monitoring activities of assets, comprising: a server; and a plurality of the electronic devices for collecting and transmitting measurement data to the server, wherein the server is configured to:

authenticate a user associated with one of the electronic devices;
receive a selection of a customer;
send a list of available assets associated with the customer to the electronic device;
receive a selection of an asset from the one of the electronic devices;
in response to receipt of the selection, associate the asset with the user; and
receive, from the one of the electronic devices, the measurement data related to the asset.

According to an aspect of the present application, there is provided a computer program product comprising instructions stored in a non-transitory computer readable medium which, when executed by a processor, causes the processor to:

authenticate a user associated with an electronic device;
receive a selection of a customer;
send a list of available assets associated with the customer to the electronic device;
receive a selection of an asset from the user;
in response to receipt of the selection, associate the asset with the user;
receive, from the electronic device, measurement data related to the asset; and
display state of the asset from the measurement data.

### BRIEF DESCRIPTION OF THE DRAWINGS

Reference will now be made, by way of example, to the accompanying drawings which show example embodiments of the present application, and in which:

FIG. 1 is a diagram illustrating a system for tracking and recording asset activities, according to an embodiment of the present application;

FIG. 2 is a diagram of a server in FIG. 1;

FIG. 3a is a diagram of an electronic device in FIG. 1;

FIG. 3b is a schematic of the I/O interface of the electronic device in FIG. 1;

FIG. 4 is a flow chart illustrating a process of the server in FIG. 2;

FIG. 5 is a flow chart illustrating a process of the electronic device in FIG. 3.

Similar reference numerals may have been used in different figures to denote similar components.

### DESCRIPTION OF EXAMPLE EMBODIMENTS

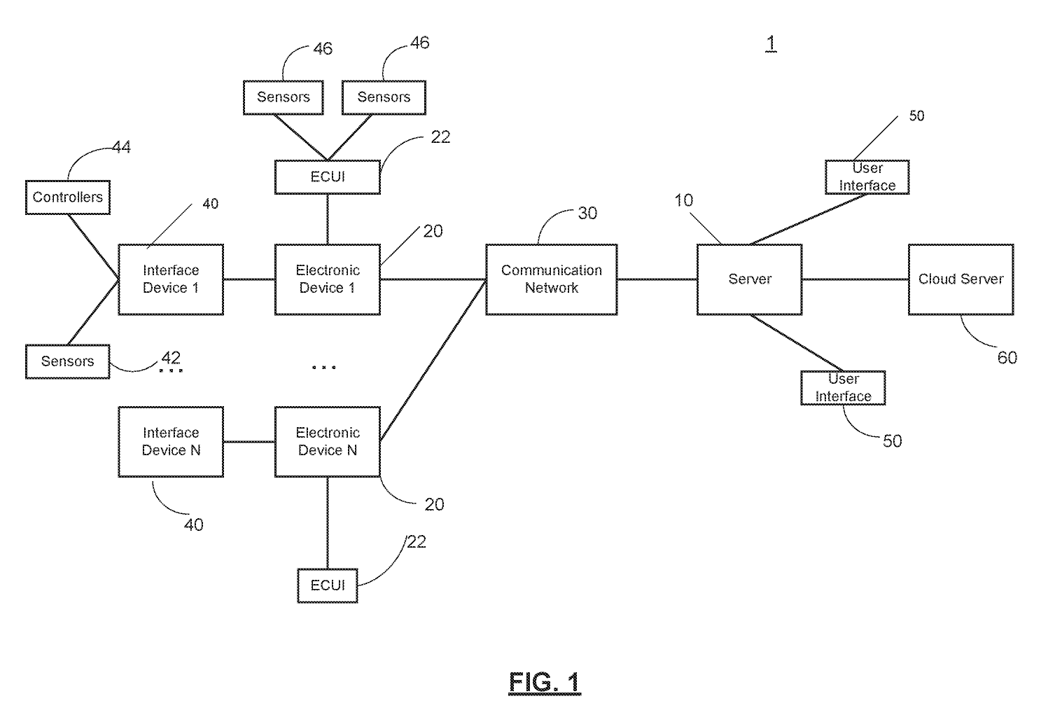

FIG. 1 illustrates an exemplary system 1 of the present application for tracking and recording the asset activities. The system 1 includes a central server 10, and a plurality of electronic devices 20. In the example of FIG. 1, the system 1 includes N electronic devices 20. The electronic devices 20 may be mobile devices, such as smart phones, tablets, or laptops. In some examples, the tablets and the laptops are capable of wireless communication. In some examples, each electronic device 20 tracks the location of an asset. The server 10 and the electronic devices 20 may communicate with each other via communication network 30. Communication network 30 may include the Internet and wireless networks, such as Wi-Fi™, 2G, 3G, 4G or 5G cellular networks.

In some examples, each of the electronic devices 20 is carried by a person operating an asset, or a driver of a vehicle, and therefore, the location of the electronic device 20 also indicates the location of the person and the asset, or the driver and the vehicle. The electronic device 20 may also generate a timestamp in association with each of the location to indicate the time of collecting the location measurement data. In some examples, at least one of the electronic devices 20 may transmit, in real time or periodically, via the communication networks, the location measurement data collected to the server 10. In some examples, at least one of the electronic devices 20 may also transmit the timestamp to the server 10 along with the location measurement data. The electronic device 20 will be described in greater detail below.

In some examples, the server 10 may process the measurement data received from the electronic devices 20 and display the processed results, such as on a report, on the user interface 50. The user interface 50 may be a display screen locally connected with server 10, or a display screen of a computer remotely connected with the server 10, such as via the Internet, with the server 10. The server 10 will be described in greater detail below.

In some examples, the system 1 may include at least one Engine Control Unit interface (ECUI) 22. Each ECUI 22 is electrically connected with an electronic device 20. The electronic device 20 may receive measurement data from a controller or sensors of an Engine Control Unit (ECU) of a vehicle via the ECUI 22. In some examples, the ECUI 22 may transmit the measurement data to the electronic device 20 using near field communications, such as Wi-Fi™, Bluetooth™ and infrared. The measurement data may relate to the operation of the engine, including speed of the vehicle, revolutions per minute (RPM), odometer, engine hours, and any error code(s). In some examples, the ECUI 22 may be existing wireless vehicle diagnostic devices.

In some examples, the system 1 may include at least one interface device 40. Each interface device 40 is electrically connected with an electronic device 20. The interface device 40 may be a digital and analog input/output (I/O) interface. With the interface device 40, the electronic device 20 may receive and collect measurement data from the vehicle or tools mounted on the vehicle, such as from sensing device 42 (for example, temperature sensors), controllers 44 (for example, salt spreader controllers and other system controllers), and sensors 46 mounted on the vehicle, or on the tools of the vehicle, such as a plow, dump, and boom. The data collected by the interface device 40 may include working state information of the vehicle, such as beacon light on/off, plow up/down, dump tipped/lowered, boom extended/cradled, etc. As such, the state of the vehicle at a time may be determined based on the working state information, such as temperature, plow status, beacon light status, boom status, etc. As well, the material dispersal and usage may be monitored indirectly, for example, winter and summer operation materials, such as salt and brine, and liquid for dust control. In some examples, the interface device 40 may include an RS232 serial port for the interface device 40 to communicate with other in-vehicle systems, such as sensing device 42, controllers 44, or sensors 46 mounted on the vehicle. In some examples, the interface device 40 may transmit the measurement data to the electronic device 20 using near field communications, such as Wi-Fi™, Bluetooth™ and infrared.

In some examples, each measurement data collected by the ECUI 22 and the interface device 40 is associated with a timestamp to indicate the time of collecting the measurement data.

As such, the ECUI 22 and the the interface device 40 may collect, from a vehicle, operational data related to the health of the vehicle and the behaviour characteristics of the driver. Accordingly, system 1 assists in time management for both the service recipients and the service provider by tracking the time period of services. The system 1 may also assist in inventory management by controlling check-in and check-out assets. The system 1 may also monitor operations of the vehicles and drivers' behavior by tracking the speed of vehicles and other operational parameters collected from the sensors and controllers from vehicles. As well, system 1 provides electronic driver logs by monitoring check-in, check-out times of a service provider, hours of service, driver vehicle inspection reports, and the locations of the vehicles at different time. Finally, the system 1 may provide vehicle diagnostics information by monitoring operation parameters of the vehicles as well, as other points of interest (downed wiring, potholes, etc. . . . ).

In some examples, the server 10 and at least one of the electronic device 20 may communicate with each other via the communication network 30. The communications may provide the user information, such as operational updates, for example changes in routes or obstructions, reprioritization of activities, driving instructions to destinations, etc. In some examples, the server 30 may send one or more messages, automatically or manually by an operator, to the electronic device 20 and the electronic device 20 may respond to the message, by the user by sending messages, such as by text messages, to the server 10. For example, to avoid distracted driving (such as by detection of motion of the asset by sensors mounted in/on the asset consistent with travel of the asset along the route), the server 10 may then send predetermined messages/responses to common questions and/or allow only predetermined responses to be sent by the electronic device 20, to minimize user input.

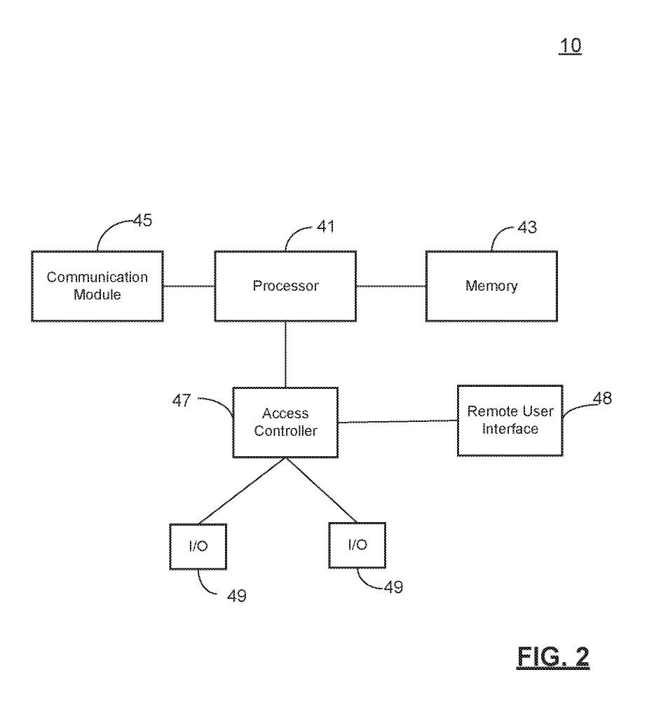

FIG. 2 illustrates an exemplary server 10. The server 10 may include a processor 41, a memory 43, and a communication module 45. The communication module 45 receives measurement data transmitted, via the communication network 30, from the electronic devices 20, such as electronic devices 1 to N. The processor 41 may process the measurement data received from the communication module 45. In some examples, the processor 41 may plot the location measurement data received from an electronic device 20 on a map to show the movement route of the electronic device 20 over a period. For example, if a snow plow truck carries an electronic device 20, the route of the electronic device 20 is also the route of the snow plow truck during a period. The processor 41 may also store to the memory 43 the measurement data received from the communication module 45 and the processed results by the processor 41. The processor 41 may also retrieve the measurement data stored in the memory 43 for processing.

In addition to storing measurement data, the memory 43 may store customer information, such as service recipients, registered in the server 10. The memory 43 may store registration information of users, such as the email addresses and the passwords assigned to respective users. The registration information of a user uniquely identifies the user in the system 1. With the registration information, the user may log into the server 10. The memory 43 may store the registration information of service providers for a service recipient and available assets under a service provider. A service provider may provide services to multiple service recipients. Once a service provider logs into the server 10, and selects a customer (service recipient), the available assets accessible to the user may be displayed.

In some examples, the server 10 may associate the username and the password with a user ID, such as a driver ID, to uniquely identify the user in the server 10. In some embodiments, a user may change their own password once logged into the server 10. The server 10 may also offer a Forgot Password option for the user to retrieve the assigned password. After the user has logged in the server 10, the user may check out an available asset, such as a vehicle. When the asset is checked out, the server 10 sets the status of the asset as unavailable. After the asset is check back into the server 10, the server 10 sets the status of the asset as available.

In some examples, a service provider may have a plurality of users or contractors. A user or contractor may be associated with a plurality of assets in the server 10. An asset may be owned by an organization or a service provider. For example, a contractor may be associated with a plurality of service vehicles. Each asset may be registered in the server 10 with a unique asset ID. As such, the server 10 can uniquely identify an asset by its asset ID. In this case, when an asset or a vehicle is checked out, the server 10 sets the status of the asset or vehicle as unavailable.

In some examples, the server 10 may include an access controller 47 to control the access to the information stored in the memory 43, such as contractor account access. The stored information may include customers, available assets to provide services to a customer, processed measurement results related to relevant assets, or measurement data of relevant assets stored in the memory 43. The access controller 47 may store and manage user IDs, asset IDs, and credentials of the users, information of customers. For example, only users authenticated by the server 10, such as by email addresses and assigned passwords, may have access to the server 10. For example, after the processor 41 has determined that credentials provided by the user match the stored credential in the access controller 47, the processor 41 instructs the access controller 47 to grant access the user.

An authorized remote user may log into the server 10, via the remoting user interface 48, for example using a standard web browser such as Internet Explorer™, Chrome™, Firefox™. An authorized local user may use a standard web browser, such as Internet Explorer™, Chrome™, Firefox™, and the like, on a local I/O device 49, such as a computer screen, to display the information generated from the memory 43 based on selected criteria. The selected criteria may include asset ID or user ID, and a selected time period, and areas of interest. The area of interest may include the locations of the asset, operational parameters collected from the sensors or controllers mounted on the asset, such as temperature of the asset, speed of the asset, and engine speed of the asset, etc. In some examples, the remote or local user may connect with the server 10 with Secure Sockets Layer (SSL).

In some examples, the measurement data may be exported from the memory 43, for example in a stream of data in an industry standard, such as the format of JSON, or XML, etc. The exported measurement data may be used by a third party. In some example, the measurement data, for example in one or more text or XML files, may be imported into the server 10 for processing from a third party. In some examples, the measurement data may be imported from the electronic device 20 by directly connecting an electronic device 20 with the server 10, for example by a USB cable or a Wi-Fi™ network, after the asset has been returned and checked back into the server 10.

In some examples, the server 10 may be a cloud server. In some examples, the server 10 may communicate with a cloud server 60 as a backup server (FIG. 1). For example, the server 10 may upload the measurement data and processed results from the memory 43 to the cloud server 60 for storage; and the server 10 may download the measurement data and processed results from the cloud server 60 to the memory 43 for processing.

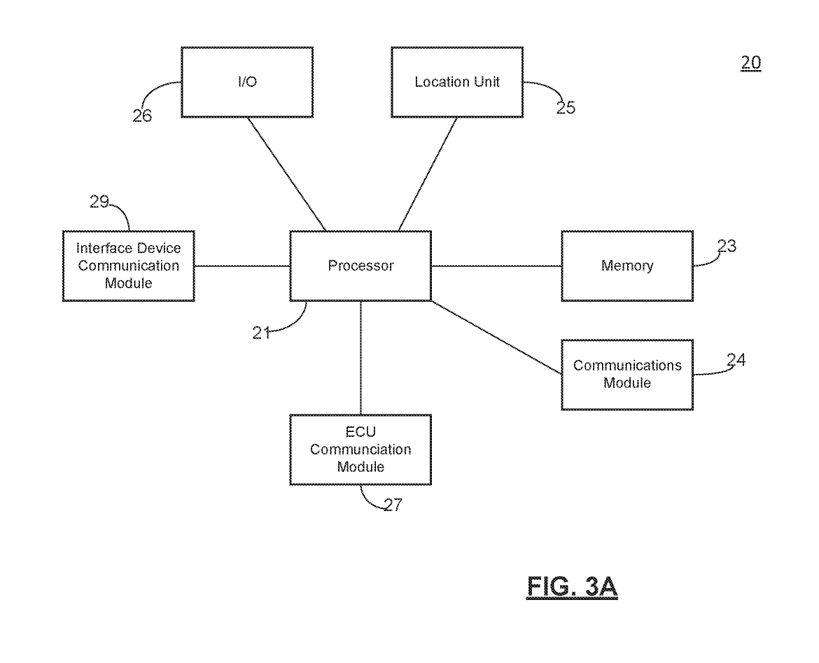

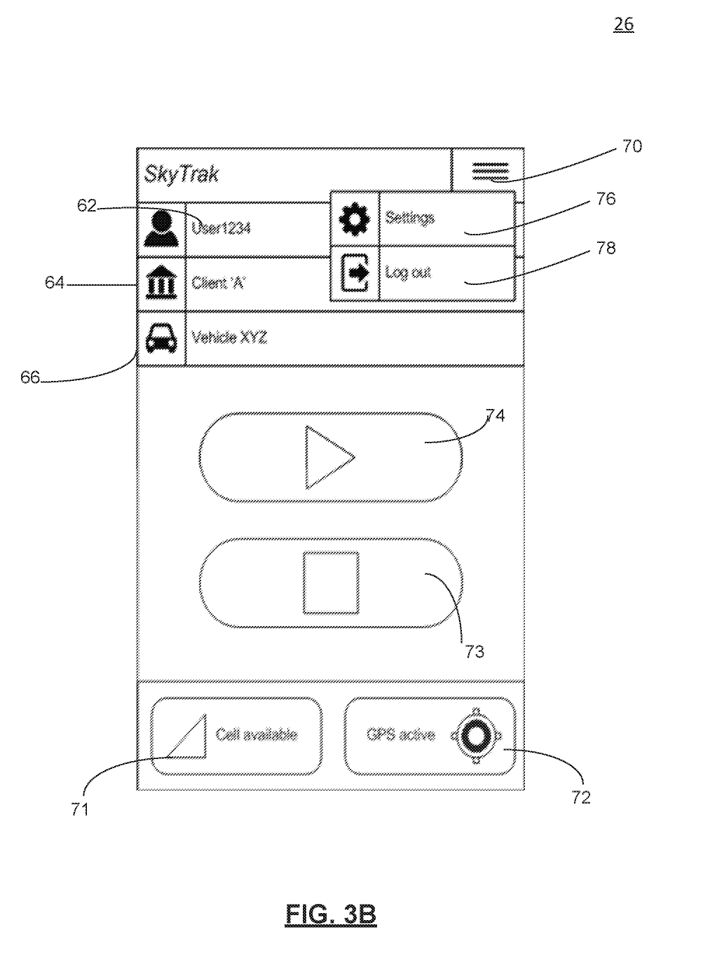

FIGS. 3A and 3B illustrate an exemplary electronic device 20. The electronic device 20 may include a processor 21, a memory 23, a communication module 24, and a location unit 25. The processor 21 may store the measurement data received by the electronic device 20 to the memory 23 or retrieve the measurement data stored in the memory 23. The communication module 24 allows the electronic device 20 to communicate with the server 21, for example, via the communication network 30. The location unit 25 tracks the position of the electronic device 20. In some examples, the location unit 25 is a Global Positioning System (GPS) receiver for receiving satellite signals and determining geographical coordinates of the electronic device 20, such as latitude and longitude of the electronic device 20.

The electronic device 20 may also include an I/O device 26, such as a screen for receiving input from a user, displaying information received from the server 10, displaying the measurement data received by the processor 21, such as the current location of the asset, and/or displaying other operational data of the asset received by the processor 21.

The electronic device 20 may also include an ECU communication module 27, to receive the measurement data from the ECUI 22. The electronic device 20 may also include an interface device communication module 29 to receive measurement data from interface device 40.

In some examples, the electronic device 20 may generate a timestamp when each measurement data is received from the location unit 25, ECU communication module 27, and the interface device communication module 29.

In use, each electronic device 20 may be placed in an asset. In some examples, the each electronic device 20 may be carried by a driver of vehicle or mounted in/on a vehicle.

A user may log into the server 10 using an electronic device 20, for example, by providing a username and a password. The electronic device 20 may remember the username and password automatically. For example, a user, such as a contractor, may log into the server 10 with an email address that is unique within server 10 and a password assigned to the user by the server 10.

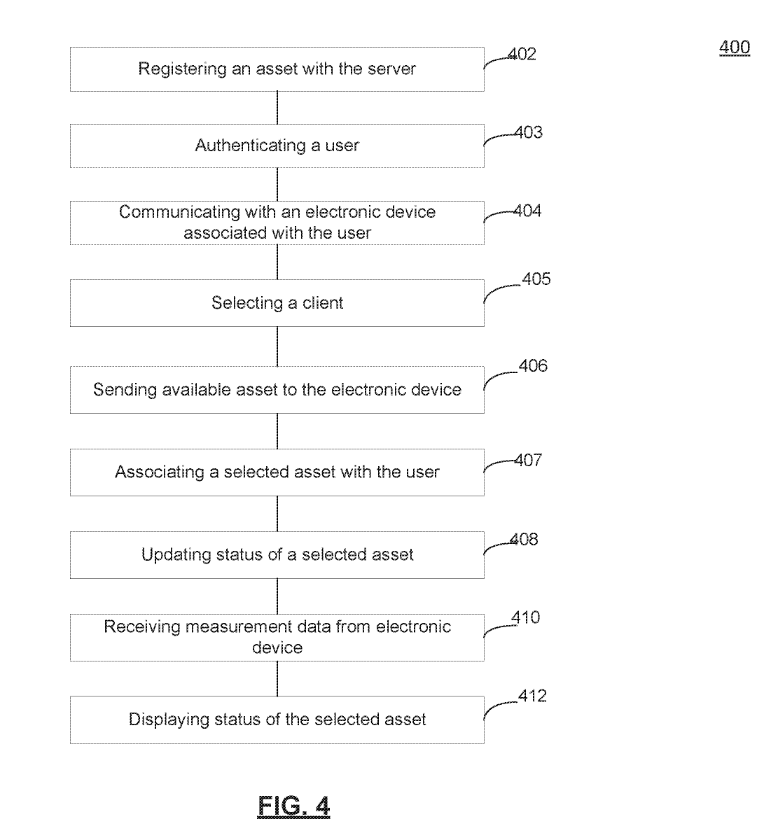

FIG. 4 illustrates an exemplary process 400 of the operation of the server 10. In use, the server 10 registers each of the assets, such as service vehicles, associated with a client, a user or a service provider (step 402). As described above, the server may assign an asset ID to uniquely identify the asset in the system 1. In some examples, the asset ID may be associated with a QR code, or a NFC tags that allows the server 10 to uniquely identify the asset. The server 10 may also registered a user, such as a contractor or a driver, and assigned each user a user ID or a driver ID to uniquely identify the user in the system 1. As well, all of the assets associated with a user or a service provider may be associated with the user or service provider by, for example, by associating the asset IDs with the user ID.

When a request, which may include a username and a password, for a user to log into the server 10 has been received from an electronic device 20, the server 10 may authenticate the user, for example, if the username, such as an email address, and assigned password received from the electronic device 20 match those stored in the memory 43. Once the access controller 47 of the server 10 has authenticated user (step 403), the server 10 may communicate with the electronic device 20 (step 404). In some examples, the user may log into the server 10 by other manners that uniquely identify the user in the server 10, such as biometric scanning, QR code scanning or by NFC tags. For example, the electronic device 20 may log into the server 10 via API. The user may select a client or customer to provide services (step 405). In some examples, the most recent customer to whom the services is provided may be set as the default customer. In an example, the server 10 may send available assets to the electronic device 20 (step 406) for displaying on the electronic device 20 available assets to the user on the I/O interface of the electronic device 20. The server 10 may send customers associated with the user for displaying on the electronic device 20. The user may select on the electronic device 20 a customer among associated customers to provide services. When the user has selected an asset, the server 10 may associate the selected asset with the user (step 407), for example, by associating the asset ID of the selected asset with the user ID to indicate that the selected asset is checked out by the user. The user may select on the electronic device 20 an available asset to be checked out. The server 10 may set the most recently used asset as the default asset for the user. Once the user has checked out an asset, such as a salt truck 66 (FIG. 3B), the server 10 will update the status of the asset (step 408), for example from “available” to “unavailable”. During the period in which an asset is checked out by a driver, the driver ID may be associated with the asset ID to indicate that the driver uses the asset. The asset with the status of “unavailable” cannot be checked out by other users until the asset is checked into the server 10 and the server 10 changes the status of the asset from “unavailable” to “available” again. After the asset has been checked out by the user, the communication module 45 of the server 10 receives, via the communication network 30, measurement data from the electronic device 20 carried by the user or placed on the asset (step 410). For example, the electronic device 20 is a smart phone or tablet carried by the user who is the driver of the checked out salt truck. In some examples, the electronic device 20 is securely mounted on the asset, for example the salt truck. The measurement data may include location data, such as GPS data, of the electronic device 20, measurement data from the sensors or controllers mounted on the asset, and timestamp in association with each measurement data. The processor 41 of the server 10 may process the measurement data received from the communication module 45, and/or save the measurement data and processed result in the memory 43 of the server 10. The processed results may indicate the status of a selected asset. The server 10 may display the processed results of the selected asset on a display screen, such as a local computer screen, a TV screen, or a remote computer screen (step 412). In some examples, the processed results may be the movement route of the salt truck during a period, for example, from checking out time to checking in time. The movement route of an asset during a period may be plotted on the map from the location measurement data received from the electronic device 20 with timestamps within the period. In some examples, the processor 41 may also be configured to display real time position of the asset, such as live GPS tracking of the asset. In some examples, the processed results are displayed on a webpage.

In some examples, the processor 41 of the server 10 may generate managerial reports or analytics based on the information stored in the memory 43. For example, the processor 41 may generate history reports of the usage of selected assets, the trip and shift reports of selected users, and route activities of the selected assets. In some examples, the processor 41 may also used to show and validate the work of a user, such as a contractor, in order to properly compensate the user.

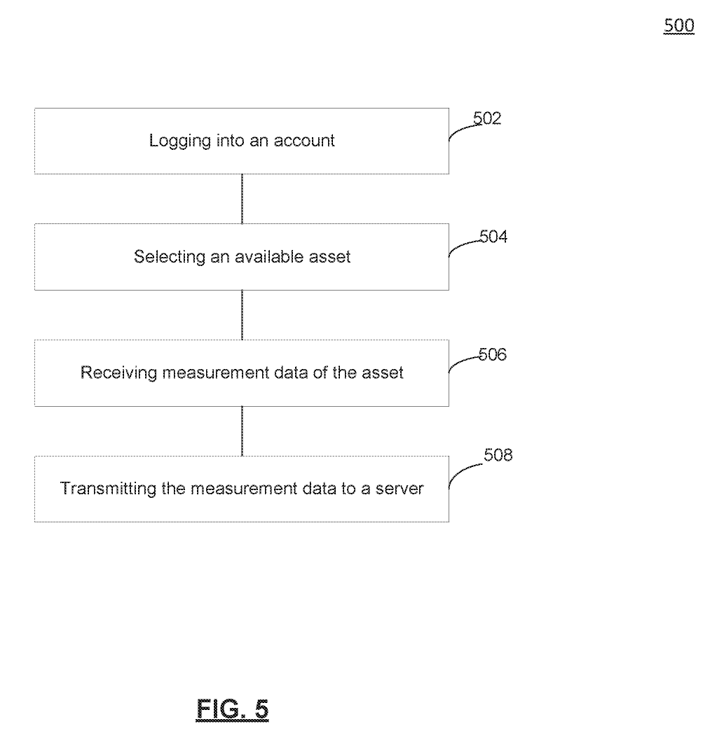

FIG. 5 illustrates an exemplary process 500 of the operation of an electronic device 20. With reference to FIG. 5 and FIG. 3B, a user, such as a contractor or a driver, first logs into the server 10 with the user's account, via an electronic device 20, for example, by using an email address registered with the server 10 and the password assigned by the server 10 (step 502). The user may select a customer displayed on the I/O interface 26, such as a municipality, department of transportation (DOT) 64 in FIG. 3B of a municipality, or a company. The user may then select an available asset (step 504), such as a vehicle, listed under the customer. For example, under a municipality, available assets may include graders, loaders, plows, and salt trucks. As an example, a contractor may select a salt truck. The username 62 in FIG. 3B, selected customer, selected asset, such as a vehicle, control buttons, and status of the GPS may be prominently displayed on the I/O interface 26 of the electronic device 20.

After the user has selected the asset, the user may start the measurement, for example, by clicking a start button 74 (FIG. 3B) on the I/O interface 26. In the example of FIG. 3b, the electronic device 20 may also display on the I/O interface 26 the status of the communications network in the settings 76 of FIG. 3B, such as “cell available” 71 or the status of the location unit 25, such as “GPS active” 72. The processor 21 may be configured, for example in a software application, to receive the measurement data from the location unit 25, ECU communication module 27, and/or the interface device communication module 29 (step 506). In some examples, the processor 21 may be configured, for example in a software application, to process the received measurement data, for example, by displaying the movement route of the asset and the current position of the asset, or by displaying operational data of the asset on the I/O interface 26, such as a screen of the electronic device 20. In some examples, the processor 21 may be configured, for example in a software application, to store the received measurement data and processed results. The software application may be stored in the memory 23. The software may be publicly available with or without a fee, for example, in the Apple Store (iOS operation system) or Google Play (Android operation system). As such, electronic device 20 can be deployed quickly and conveniently by downloading the software on a smart phone or a tablet of a user, without extra hardware.

In some examples, the electronic device 20 or the processor 21 may transmit the measurement data to the server 10 (step 508). The electronic device 20 may transmit the measurement data to the server 10 in real time. The electronic device 20 may also transmit the received measurement data to the server 10 periodically with a frequency predetermined by the server 10. For example, the electronic device 20 may transmit the received measurement data to the server 10 once in every 2 seconds. In some examples, an electronic device 20 may transmit the measurement data as scheduled by the server 10. Before the electronic device 20 is scheduled to transmit measurement data, the measurement data may be queued and store in memory 23. When it is the scheduled time for the electronic device 20 to transmit the measurement data, the processor 21 transmits stored data in the memory 23 for transmission. In some examples, if the communication network 30 is unavailable, the location measurement data may be stored in memory 23 and queued for transmitting so that no data is lost.

The measurement data transmitted to the server 10 may include, for example: asset ID (such as a truck ID), a user's ID (such as a driver's ID), location measurement data (such as latitude and longitude), the travelling direction of the asset, the travelling speed of the asset, and timestamp of the measurement data.

In some examples, the electronic device 20 may transmit to the server 10 a most accurate measurement data of all the measurement data received during a predetermined period. For example, sometimes, the location measurement data, such as latitude and longitude, of the asset generated by the location unit 25 may not meet an accuracy threshold, and its accuracy varies based on local terrain and other obstructions. For example, particular areas are especially prone to inaccurate location measurement data, including highway on/off-ramps and interchanges, roads along heavily sloped hills, roads running alongside bridges and elevated highways, and roads through forests with high trees very near the road.

The location measurement data may be determined from multiple sources, including location unit 25, such as a GPS receiver, signals for the cellular sites or signals from Wi-Fi™ triangulation, compass, magnetometer, gyroscope and accelerometer sensors. All of these data sources may have a certain level of inaccuracy. Generally, the location provider provide an accuracy rating to the positions. For example, a 10 meters accuracy may denote that actual location of 80% of all received locations is within 10 meters of the reported position. In addition to sensor-related inaccuracy, changing Wi-Fi™ or cellular network topologies and the delay before the location provider's data can be updated may contribute to inaccurate location reports.

In some examples, the processor 21 is configured to analyze the measurement data and filter out implausible location measurement data. For example, implausible location measurement data may indicate significant changes of the location of an asset over a short period. For example, the location of an asset changes over 100 meters within 1 second. If an accuracy threshold for transmitting the measurement location data to the server 10 is too strict, very fewer or no location measurement data is transmitted to the server 10 over a period and thus this may create a measurement data gap.

In some examples, the processor 21 is configured to apply a dynamic accuracy threshold for transmitting a location measurement data. The dynamic accuracy threshold provides a balance between accuracy and frequency of transmitting the location measurement data. The dynamic accuracy threshold may be determined based on different criteria, such as one or more of time periods, distances, and accuracies in the problematic areas where the asset is located.

For example, the processor 21 set a minimum desired accuracy, such as 5 meters. Until a location measurement data received from the location unit 25 is equal or higher than the minimum desired accuracy, the processor 21 does not transmit the location measurement data but only saves the measurement data to the memory 23. As time passes, the minimum acceptable accuracy threshold may be relaxed. For example, after a defined period, such as 60 seconds, if the processor 21 has not received location measurement data that satisfies the minimum desired accuracy, the minimum acceptable accuracy threshold may be increased to a greater threshold, such as 100 meters. The processor 21 may then interpolate a curve representing the dynamic accuracy threshold over time. The processor 21 transmits a location data interpolated from the curve to provide the most accurate available data. In this example, the dynamic accuracy threshold is adjusted based on the elapsed time.

In some examples, the dynamic accuracy threshold may be adjusted based on urgency. Urgency may be determined from multiple factors, such as the distance that the asset seemed to have traveled, the duration since the last transmitted location measurement data from the electronic device 20 to the server 10, the maximum speed since the last transmitted location measurement data to the server 10, etc. As such, urgency gradually increases as time passes, and increases more quickly if a new higher travel speed is measured, and continues increasing as the processor 21 receives consistent speed increase during a period, such 10 seconds. As urgency increases, the minimum acceptable accuracy threshold may be increased to a greater threshold, for example, from 5 meters to 100 meters, or 200 meters, etc.

The processor 21 may also be configured to improve the accuracy of the initial start and end locations of an asset. Initial start and end locations are the most prone to inaccuracy. For example, the GPS receiver may not work properly when start using an asset, such driving a salt truck, as it takes time for a GPS receiver to receive multiple satellite signals above the sensitivity level of the GPS receiver before generating an accurate position. In some examples, the processor 21 is configured to improve the accuracy of the received initial start location measurement data and the end location measurement data. If the processor 21 receives an initial start location measurement data of the asset with an accuracy below the minimum acceptable accuracy threshold, the processor 21 may store the initial start location measurement data in the memory 23 without transmitting the start location measurement data to the server 10. The processor 21 keeps receiving and storing location measurement data received within a predetermined period, such as 5 seconds. If a location measurement data among a plurality of the received location measurement data is more accurate than the initial start location measurement data, the processor 21 may transmit the more accurate location measurement data to the server 10 as the start location measurement data. If a more accurate location measurement data is unavailable within a predetermined period, the processor 21 transmits the initial location measurement data as the start location measurement data.

Similarly, the end location measurement data may be determined and transmitted to the server 10 in the similar manner as described above. For example, if a location measurement data among the received location measurement data within a predetermined period before the end time is more accurate than the end location measurement data received at the end time, the processor 21 may transmit the more accurate location measurement data to the server 10 as the end location measurement data. If a more accurate location measurement data is unavailable, the processor 21 transmits the end location measurement data.

As such, by applying dynamic accuracy threshold in transmitting the location measurement data to the server 10, accuracy of the measurement location data may be improved by filtering out location measurement data below the minimum desired accuracy, while still avoiding long gaps for transmitting measurement location data.

Transmitting measurement data periodically or transmitting filtered selectively may reduce the usage of the communication network 30 and thus may reduce the costs.

As different countries may have different data residency requirements, there may be separate servers and databases for different countries. In some examples, the processor 21 uses different versions of software in different countries, such as different versions of the software for Canada and US. In the regard, the processor 21 may be configured to display on the I/O interface 26 national flag of a selected country. In some examples, the processor 21 may be configured to display control buttons, such as start and stop buttons 73, 74 in FIG. 3B on the on the I/O interface 26. The processor 21 may be configured to display a bold color scheme that indicates the current state of the user's shift.

In some examples, the processor 21 may be configured to display communication status with the server 10, including timestamp of last successful communication, current queue backlog size in the memory 23, location measurement data availability for transmission. In some examples, the processor 21 may be configured to trigger the vibrate function at predetermined frequency after the user has started the measurement. The user may turn on or off this vibration function or set the vibration frequency at 5 minutes, 10 minutes, or 15 minutes. As well, the processor 21 may be configured to display on the I/O interface 26 an indication of tracking status of the asset in the “notification area” of the electronic device 20.

At the end of the service, the user may stop the measurements of the electronic device 20, for example by clicking a stop button 74 on the I/O interface 26, and log out from the server 10. The user may then proceed to log out 76 (FIG. 3B) from the server 10. In other examples, the user may remain logged in to the system 1 to expedite the start of the next trip.

As described above, the server 10 may receive measurement data from each of the electronic devices 20 1-N simultaneously or at different times. As such, the system 1 therefore can track and manage a plurality of assets, such as a fleet of service vehicles.

The system 1 and the processes 400 and 500 allows a service recipient to track and record asset activities of service providers, such as contractors, using their own vehicles or company vehicles, to provided services, such as snow clearing garbage collection, mowing, paving, and the like, so that the service receiver can verify the work performed, compensate the service providers according to time worked, avoid potential fraud by paying only for work that has been performed, identify the location of where the user started and stopped their work, as well as track the points in between, and in some cases, to manage the routes being serviced.

Although the exemplary embodiments described herein employ the memory, other types of computer readable media which can store data that are accessible by a computer, such as magnetic cassettes, flash memory cards, digital versatile disks, cartridges, random access memories (RAMs), read only memory (ROM), USB or memory sticks, a cable or wireless signal containing a bit stream and the like, also may be used in the exemplary operating environment. Non-transitory computer-readable storage media expressly exclude media such as energy, carrier signals, electromagnetic waves and signals per se. The processor described in the server 10 and electronic device 20 may be a central processing unit (CPU).

While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the broad scope of the invention.

Certain adaptations and modifications of the described embodiments can be made. Therefore, the above discussed embodiments are considered to be illustrative and not restrictive.

1. A method of monitoring activities of an asset, comprising:
authenticating a user associated with an electronic device;
receiving a selection of a customer;
sending a list of available assets associated with the customer to the electronic device;
receiving a selection of an asset from the user;
in response to receipt of the selection, associating the asset with the user;
receiving, from the electronic device, measurement data related to the asset; and
displaying state of the asset from the measurement data.

2. The method of claim 1, wherein the measurement data includes location measurement data of the asset.

3. The method of claim 1, wherein the measurement data is associated with a timestamp.

4. The method of claim 2, wherein the location measurement data meets a minimum desired accuracy.

5. The method of claim 1, wherein the measurement data is generated using a dynamic accuracy threshold.

6. The method of claim 5, wherein the dynamic accuracy threshold is determined based on time.

7. The method of claim 5, wherein the dynamic accuracy threshold is determined based on at least one of time periods, distances, and location accuracy in a selected area where the asset is located.

8. The method of claim 1, wherein the measurement data is temperature of the asset, speed of the asset, engine speed of the asset, or combinations thereof.

9. The method of claim 1, wherein the measurement data is plow status, beacon light status, boom status of the asset, or combinations thereof.

10. The method of claim 1, further comprising storing the measurement data in a memory.

11. The method of claim 1, wherein the measurement data is received from a cellular communication network.

12. A system for monitoring activities of assets, comprising:
a server; and
a plurality of the electronic devices for collecting and transmitting measurement data to the server,
wherein the server is configured to:
authenticate a user associated with one of the electronic devices;
receive a selection of a customer;
send a list of available assets associated with the customer to the electronic device;
receive a selection of an asset from the one of the electronic devices;
in response to receipt of the selection, associate the asset with the user; and
receive, from the one of the electronic devices, the measurement data related to the asset.

13. The system of claim 12, further comprising an interface device electrically connected with the one of the electronic devices for collecting measurement data from sensors, and electronic controllers of the asset.

14. The system of claim 12, further comprising an Engine Control Unit interface electrically connected with the one of the electronic devices for collecting measurement data from sensors and controller of an engine of the asset.

15. The system of claim 12, wherein the one of the electronic devices comprises a location unit for generating location measurement data of the asset.

16. The system of claim 12, wherein the server comprises an access controller for controlling access to information stored in the server.

17. A computer program product comprising instructions stored in a non-transitory computer readable medium which, when executed by a processor, causes the processor to:
authenticate a user associated with an electronic device;
receive a selection of a customer;
send a list of available assets associated with the customer to the electronic device;
receive a selection of an asset from the user;
in response to receipt of the selection, associate the asset with the user;
receive, from the electronic device, measurement data related to the asset; and
display state of the asset from the measurement data.

18. The computer program product of claim 17, wherein the measurement data includes location measurement data of the asset.

19. The computer program product of claim 17, wherein the measurement data is associated with a timestamp.

20. The computer program product of claim 17, wherein the measurement data is generated using a dynamic accuracy threshold.
